(19) United States
(12) Patent Application Publication
(10) Pub. No.: US 2009/0055419 A1
(43) Pub. Date: Feb. 26, 2009

(54) METHOD AND SYSTEM FOR CONTENT RESYNDICATION

(75) Inventors: David Gibbon, Lincroft, NJ (US); Andrea Basso, Marlboro, NJ (US); Lee Begeja, Gillette, NJ (US); Zhu Liu, Marlboro, NJ (US); Bernard S. Renger, New Providence, NJ (US); Behzad Shahraray, Freehold, NJ (US)

Correspondence Address: SCHWEGMAN, LUNDBERG & WOESSNER, P.A., P.O. BOX 2938, MINNEAPOLIS, MN, 55402, US

(73) Assignee: AT&T Labs, Inc

(21) Appl. No.: 11/842,832

(22) Filed: Aug. 21, 2007

(51) Int. Cl. G06F 7/00

(52) U.S. Cl. 707/101; 707/E17.006

(57) ABSTRACT

Methods and systems for providing content. Syndicated content may be received from a content syndication source. The syndicated content may be augmented with metadata. The augmented content may be provided through a target syndication feed.

### FIELD

This application relates to a method and system for content processing, and more specifically to methods and systems for providing content.

### BACKGROUND

A user may seek syndicated content from a syndicated content source. However, the user may be unable to receive and utilize the syndication content because a device used by the user is incompatible with the content format provided by the syndicated content source.

### BRIEF DESCRIPTION OF DRAWINGS

Embodiments are illustrated by way of example and not limitation in the figures of the accompanying drawings, in which like references indicate similar elements and in which:

FIG. 1 is a block diagram of an example content system according to an example embodiment;

FIG. 2 is a block diagram of an example resyndicator that may be deployed in the content system of FIG. 1 according to an example embodiment;

FIG. 3 is a flowchart illustrating a method for providing content in accordance with an example embodiment;

FIGS. 4-6 are flowcharts illustrating a method for content augmentation in accordance with an example embodiment;

FIGS. 7-9 are flowcharts illustrating a method for generating an additional format in accordance with an example embodiment;

FIG. 10 is a flowchart illustrating a method for providing augmented content in accordance with an example embodiment;

FIG. 11 is a flowchart illustrating a method for generating an additional format in accordance with an example embodiment;

FIGS. 12 and 13 are flowcharts illustrating a method for providing content in accordance with an example embodiment;

FIG. 14 is a block diagram of an IPTV system in which the content system of FIG. 1 may be deployed in accordance with an example embodiment; and

FIG. 15 illustrates a diagrammatic representation of a machine in the example form of a computer system within which a set of instructions for causing the machine to perform any one or more of the methodologies discussed herein may be executed.

### DETAILED DESCRIPTION

Example methods and systems for providing content are described. In the following description, for purposes of explanation, numerous specific details are set forth in order to provide a thorough understanding of example embodiments. It will be evident, however, to one skilled in the art that the present invention may be practiced without these specific details.

In an example embodiment, syndicated content may be received through a source syndication feed from a content syndication source. The syndicated content may be augmented with metadata. The augmented content may be provided through a target syndication feed.

In an example embodiment, syndicated content may be received from a plurality of content syndication sources. A portion of the syndicated content may be selected from the plurality of content syndication sources. The selected portion of syndicated content from the plurality of content syndication sources may be augmented with metadata. The augmented content may be provided through a target syndication feed.

In an example embodiment, syndicated content may be received from a content syndication source. A plurality of portions of the syndicated content may be selected from a content syndication source. The selected plurality of portions of the syndicated content may be augmented with metadata. The augmented content may be provided through a target syndication feed.

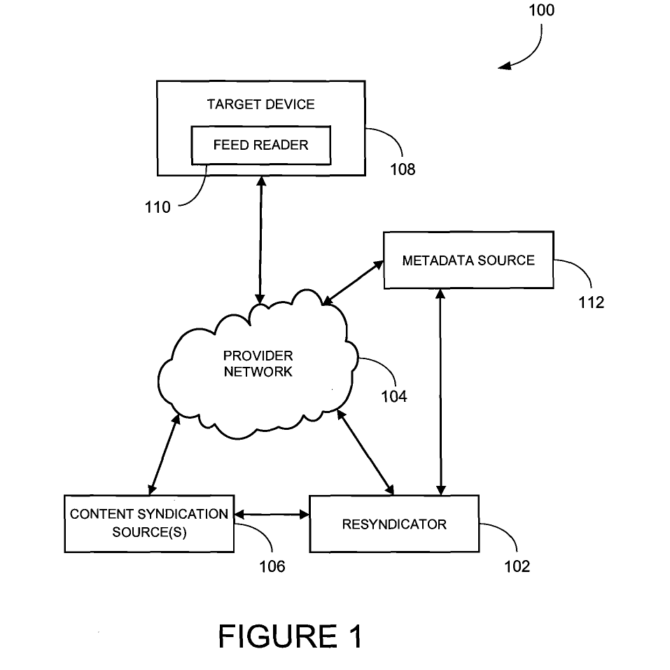

FIG. 1 illustrates an example content system 100. The content system includes a resyndicator 102 that may receive syndicated content from a content syndication source 106 through a source syndication feed and provide resyndicated content over a provider network 104 through a target syndication feed to a feed reader 110 of a target device 108. The resyndicator 102 may be a proxy, a gateway, or a different type of element in the system 100.

The syndicated content may be content sent through the provider network 104 to the syndicator 102 when the syndicator 102 has subscribed to a syndicated feed of syndicated content from the content syndication source. The syndicator 102 may then check one or more syndication feeds of the syndicated content on a periodic basis to receive content that has been made available for receipt through the feed (e.g., directly from the feed and/or a link to syndicated content within the feed). The resyndicator 102 may resyndicate the syndicated content by modifying the received feed of the syndicated content to reflect additional or different formats of syndicated content and/or additional metadata not present in the received feed.

The resyndicated content provided by the resyndicator 102 to the target device 108 through the target syndication feed may include the syndicated content with metadata not present in the syndicated content received in the original format from the content syndication source 106. The target syndication feed may be in RSS feed format or another format. The metadata used to augment the syndicated content may be generated by the resyndicator 102, accessed from a metadata source 112 (e.g., a transcript), or otherwise received. The resyndicated content may also be in a different format from the original format.

The resyndicated content provided by the resyndicator 102 may include text data, audio data, image data, video data, and the like. Other types of data may also be used.

The metadata associated with the resyndicated content may include a rendering instruction, a publication instruction, or a different type of instruction. The metadata associated with the resyndicated content may be associated (e.g., through a pointer) with additional text data, audio data, image data, video data, and the like. The metadata may be included in the target syndication feed with the syndicated content or a link to the metadata and/or other data may be provided in the target syndication feed. Other data types and formats may also be used.

The provider network 104 may be a television distribution network, Global System for Mobile Communications (GSM) network, an Internet Protocol (IP) network, a Wireless Application Protocol (WAP) network, and/or a WiFi network. Other networks may also be used.

The content syndication source 106 may be a computer system or other device providing image data, audio data, video data, text data, and the like through a source syndication feed. The target device 108 may be a set top box (STB), a television monitor, a receiver card, a mobile telephone, a portable gaming device, a personal digital assistant (PDA), a computer system, and the like. Other types of devices may also be used.

In an example embodiment, the resyndicated content (e.g., syndicated content augmented with metadata and/or in an additional format) provided by the resyndicator 102 through the target syndication feed may enable more target devices 108 to receive the syndicated content than would otherwise be able to do so from the syndicated content provided by the content syndication source 106. The target device 108 may better process the resyndicated content received. The association of the metadata with the syndicated content by the resyndicator 102 may provide additional information to the user of the target device 108.

In an example embodiment, even when the format of the syndicated content provided by the content syndicated source 106 is compatible with the target device 108, the provided format may not be provided in a format that is targeted for the target device 108 without use of the resyndicator 102. For example, the target device 108 may be capable of reproducing only low resolution or bit rate signals but the format of the syndicated content may be provided by the content syndication source 106 as a high quality signal. In addition, the received content may not include accompanying information that could be helpful to the user and/or the target device 108 that reproduces the content without use of the resyndicator 102.

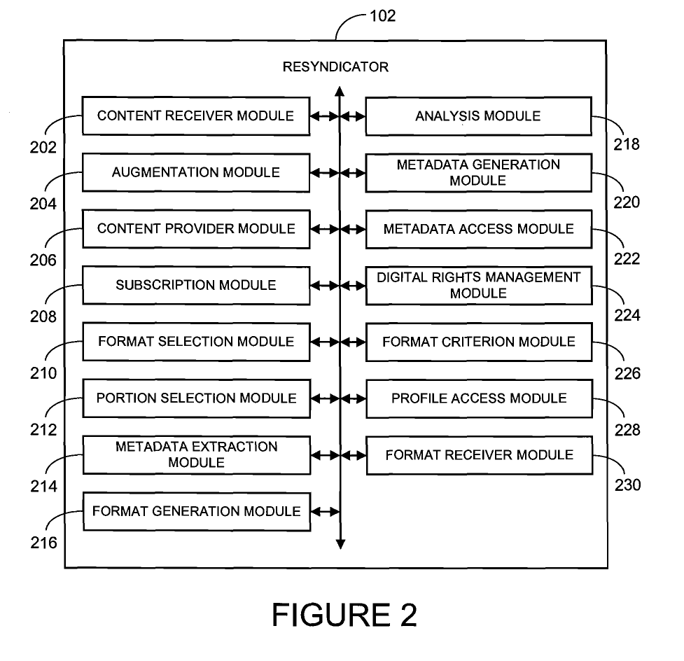

FIG. 2 illustrates an example resyndicator 102 that may be deployed in the content system 100 (see FIG. 1) and/or another system.

The resyndicator 102 may include a content receiver module 202, an augmentation module 204, a content provider module 206, a subscription module 208, a format selection module 210, a portion selection module 212, a metadata extraction module 214, a format generation module 216, an analysis module 218, a metadata generation module 220, a metadata access module 222, a digital rights management (DRM) module 224, a format criterion module 226, a profile access module 228, and/or a format receiver module 230. Other modules may also be used.

The content receiver module 202 receives syndicated content from the content syndication source 106 through a source syndication feed. The augmentation module 204 augments the syndicated content with metadata. The augmentation performed by the augmentation module 204 may include augmenting existing metadata of the syndicated content with additional metadata and/or augmenting the syndicated content in the additional format with the existing metadata.

The content provider module 206 provides the augmented content (e.g., the resyndicated content) in one or more formats through a target syndication feed.

The subscription module 208 subscribes to a source syndication feed of the content syndication source 106. The format selection module 210 selects an original format from a number of available content formats of the syndicated content.

The portion selection module 212 selects a portion of the syndicated content for augmentation with metadata (e.g., new metadata or additional metadata) and resyndication (e.g., to be sent out to the target device 108 through a syndication feed). The metadata extraction module 214 extracts existing metadata from an original format of the syndicated content.

The format generation module 216 generates an additional format of the syndicated content. The analysis module 218 analyzes the syndicated content and/or existing metadata.

The metadata generation module 220 generates the metadata from the analysis of the syndicated content and/or the existing metadata performed by the analysis module 218. The metadata access module 222 accesses the existing metadata for the syndicated content from the metadata source 112.

The DRM module 224 determines DRM associated with the syndicated content in an original format, adds the DRM to the additional format, circumvents the DRM associated with the original format, and/or unlocks the DRM associated with the original format.

The format criterion module 226 utilizes a format criterion to determine a format type of the syndicated content. The profile access module 228 accesses a user profile. The format receiver module 230 receives a format selection request.

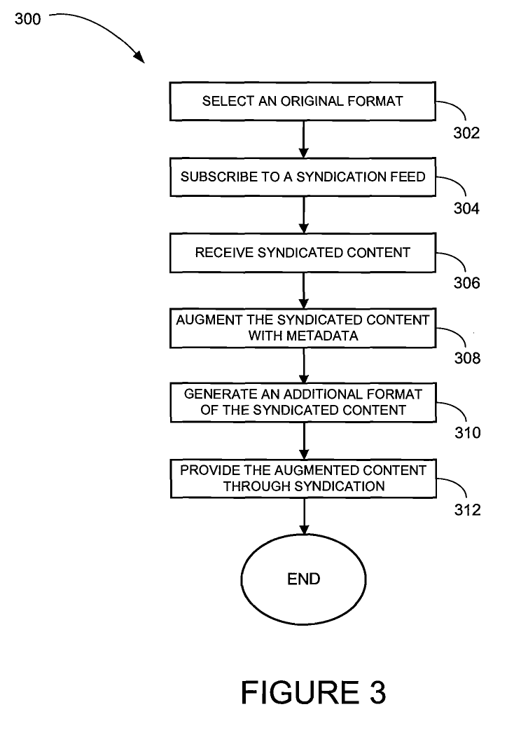

FIG. 3 illustrates a method 300 for providing content according to an example embodiment. The method 300 may be performed by the resyndicator 102 of the content system 100 or otherwise performed.

An original format of syndicated content may be selected from a number of available content formats of the syndicated content. The available content formats may be available from a single content syndication source 106 or multiple content syndication sources 106.

A subscription may be made to a source syndication feed of the content syndication source 106 at block 304. The subscription may enable syndicated content to be received through the source syndication feed from the content syndication source 106.

Syndicated content (e.g., in an original format) is received from the content syndication source 106 at block 306. The syndication feed may be in RSS format may include XML and one or more pointers to the syndicated content and existing metadata.

The syndicated content is augmented with metadata at block 308. For example, new metadata may augment the syndicated content or existing metadata of the syndicated content may be augmented with additional metadata.

The metadata selected for augmentation may be explicitly expressed by the user, implicitly detected by the resyndicator 102, and/or available to a single user or multiple users.

In an example embodiment, a portion of the syndicated content may be selected for augmentation and resyndication and the portion of the syndicated content may be augmented with metadata.

In an example embodiment, the syndicated content may be augmented with the metadata by aligning the metadata with the syndicated content. Aligning the metadata may time synchronize the metadata to the syndicated content so that both are available for coordinated presentation.

An additional format of the syndicated content may be generated at block 310. The additional format may additional data that is be generated by transcoding the syndicated content to generate the additional format and/or modifying at least one parameter of the syndicated content in an original format. The modified parameter of the original format may include, by way of example, a picture size, a frame rate, and/or a content format. Other parameters may also be used. The additional format may be explicitly expressed by the user and/or implicitly detected by the resyndicator 102. The additional format may be generated in other ways.

The additional format may be a different display resolution than the original format and/or a different encoding format than the original format. The additional format may be an additional device format and/or an additional media format. Other types of additional formats may also be used. In an example embodiment, the additional format may be generated by converting the content into a new media format. For example, image data and audio data may be converted into video data.

The augmented content is provided in at least one format (e.g., the original format and/or the additional format) through a target syndication feed at block 312. The augmented content may be provided through syndication to the content syndication source 106, to the target device 108, or otherwise provided.

By way of an example, a source syndication feed for example syndicated content video.wmv may be as follows:

```
<?xml version=“1.0” encoding=“UTF-8”?>
<rss version=“2.0”>
  <channel>
  <title>World Cup Soccer, Third Place Match: Germany vs.
  Portugal</title>
  <link>http://source.research.att.com</link>
  <description>Clip from game.</description>
  <language>en-us</language>
  <image>
    <title>World Cup Soccer Channel</title>
    <url>http://source.research.att.com/channel.jpg</url>
    <link>http://source.research.att.com</link>
    <description>2006 World Cup Soccer Channel</description>
    <width>200</width>
    <height>100</height>
  </image>
<item>
<title>World Cup Soccer, Third Place Match: Germany vs. Portugal,
Saturday, July 08, 2006 2:54 PM</title>
<pubDate>Sat, 08 Jul 2006 16:01:08 GMT</pubDate>
<description>From Stuttgart, Germany.</description>
<link>http://source.research.att.com/item1/</link>
<enclosure type=“video/x-ms-asf”
url=“http://source.research.att.com/item1/video.wmv”/>
</item>
</channel>
</rss>
```

The syndicated content of the above example may be processed by the resyndicator 102 to output thumbnails, text, transcoded video and MP3 audio. The additional data may be added to a target syndicated feed as shown in the example that follows:

```
<?xml version=“1.0” encoding=“UTF-8”?>
<rss version=“2.0” xmlns:media=“http://search.yahoo.com/mrss/”>
  <channel>
  <title>World Cup Soccer, Third Place Match: Germany vs. Portugal</title>
  <link>http://source.research.att.com</link>
  <description>Clip from game.</description>
  <language>en-us</language>
  <image>
    <title>World Cup Soccer Channel</title>
    <url>http://source.research.att.com/channel.jpg</url>
    <link>http://source.research.att.com</link>
    <description>2006 World Cup Soccer Channel</description>
    <width>200</width>
    <height>100</height>
  </image>
<item>
<title>World Cup Soccer, Third Place Match: Germany vs. Portugal, Saturday, July 08,
2006 2:54 PM</title>
<pubDate>Sat, 08 Jul 2006 16:01:08 GMT</pubDate>
<description>From Stuttgart, Germany.</description>
<link>http://source.research.att.com/item1/</link>
<enclosure type=“video/x-ms-asf”
url=“http://source.research.att.com/item1/video.wmv”/>
<media:group>
<media:content medium=“video” bitrate=“2000” type=“video/x-ms-asf”
url=“http://target.research.att.com/item1/video.wmv”/>
<media:content medium=“video” bitrate=“600” type=“video/x-ms-asf”
isDefault=“true” url=“http://target.research.att.com/item1/video600.wmv”/>
<media:content medium=“video” bitrate=“150” type=“video/x-ms-asf”
isDefault=“true” url=“http://target.research.att.com/item1/video150.wmv”/>
<media:content medium=“audio” bitrate=“128” type=“audio/mp3”
url=“http://target.research.att.com/item1/audio.mp3”/>
<media:content type=“image/jpeg” url=“http://target.research.att.com/item1/t.jpg”
/>
</media:group>
<media:thumbnail url=“http://target.research.att.com/item1/t1.jpg” width=”80”
time=“00:04:01.000” />
<media:thumbnail url=“http://target.research.att.com/item1/t2.jpg” width=“80”
time=“00:08:11.000” />
<media:thumbnail url=“http://target.research.att.com/item1/t3.jpg” width=“80”
time=“00:12:42.000” />
<media:text type=“plain” lang=“en” start=“00:00:00.000”
end=“00:00:5.000”>Welcome to the third place match of the 2006 World
Cup.</media:text>
<media:text type=“plain” lang=“en” start=“00:00:05.000” end=“00:00:10.000”>We
are in Stuttgart, Germany for a much anticipated match between Germany, the host
country, and Portugal.</media:text>
<media:text type=“plain” lang=“en” start=“00:00:10.000”
end=“00:00:15.000”>Tomorrow, Italy will play France in the final in Berlin,
Germany.</media:text>
</item>
</channel>
</rss>
```

In an example embodiment, the target syndication feed may include one or more pointers back to the content syndication source 106 for the syndicated content in the original format and include one or more pointers to the resyndicator 102 for the derived content.

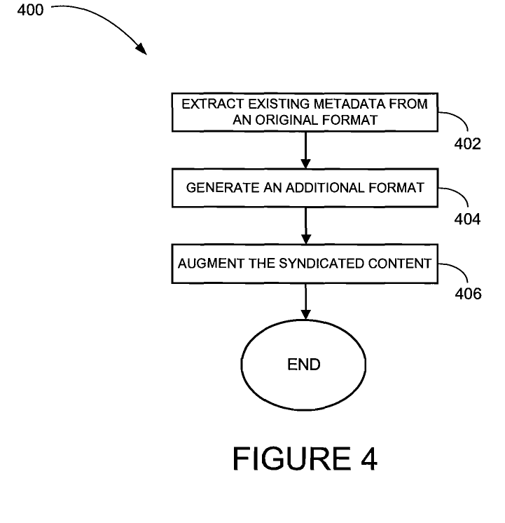

FIG. 4 illustrates a method 400 for content augmentation according to an example embodiment. The method 400 may be performed at block 308 (see FIG. 3) or otherwise performed.

Existing metadata is extracted from an original format of the syndicated content at block 402. An additional format of the syndicated content is generated at block 404. The syndicated content in the additional format is augmented with the existing metadata at block 406.

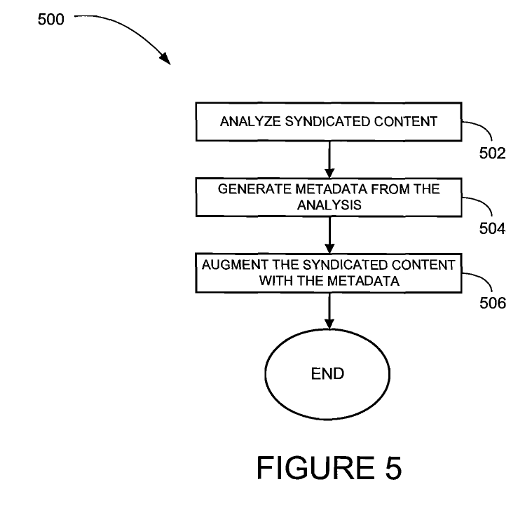

FIG. 5 illustrates a method 500 for content augmentation according to an example embodiment. The method 500 may be performed at block 308 (See FIG. 3) or otherwise performed.

The syndicated content is analyzed at block 502. The metadata is generated from the analysis of the syndicated content at block 504. The syndicated content is augmented with the metadata at block 506.

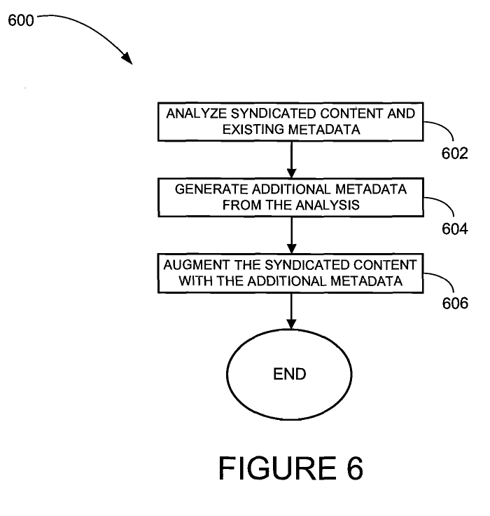

FIG. 6 illustrates a method 600 for content augmentation according to an example embodiment. The method 600 may be performed at block 308 (see FIG. 3) or otherwise performed.

The syndicated content and existing metadata is analyzed at block 602. The existing metadata may be associated with the syndicated content. The existing metadata may already be associated with the syndicated content, be accessed from the metadata source 112, and/or otherwise be accessed.

The existing metadata may be general metadata and the additional metadata may be content specific metadata. The general metadata may be more general information that is typically provided by a user, while the content specific metadata may include a number of details regarding the content and is typically generated by a computing system.

Additional metadata is generated from the analysis at block 604. The additional metadata may include, by way of example, a thumbnail image or speech recognized text. Other types of additional metadata may also be used.

The syndicated content is augmented with the additional metadata at block 606.

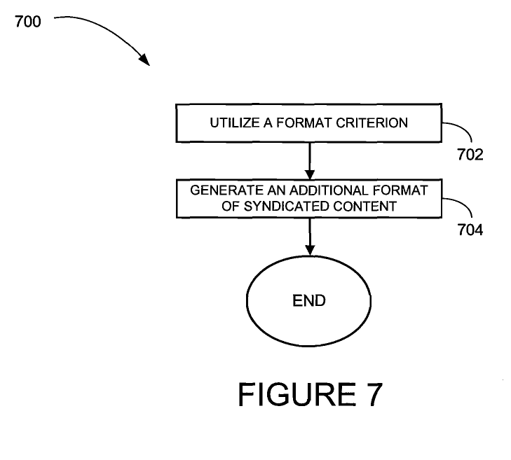

FIG. 7 illustrates a method 700 for generating an additional format according to an example embodiment. The method 700 may be performed at block 310 (see FIG. 3) or otherwise performed.

At block 702, a format criterion is utilized to determine a format type of the syndicated content. The format criterion may be, by way of example, a display size of the target device 108, a capability of the provider network 104, and/or a coverage area of the provider network 104. Other format criteria may also be used.

The additional format of the syndicated content is generated based on the determination at block 704.

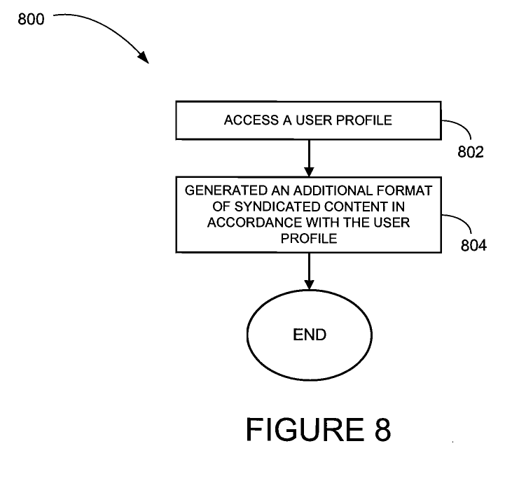

FIG. 8 illustrates a method 800 for generating an additional format according to an example embodiment. The method 800 may be performed at block 310 (see FIG. 3) or otherwise performed.

A user profile is accessed at block 802. At block 802, the additional format of the syndicated content is generated in accordance with the user profile.

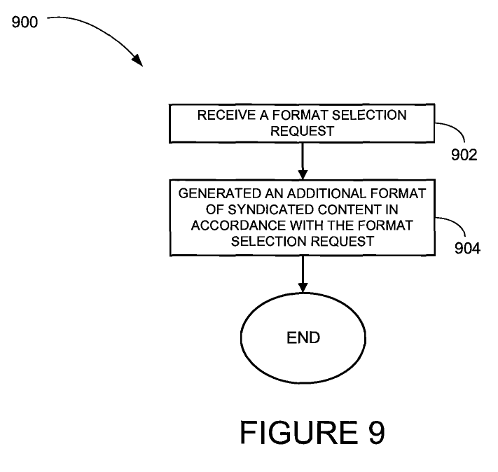

FIG. 9 illustrates a method 900 for generating an additional format according to an example embodiment. The method 900 may be performed at block 310 (see FIG. 3) or otherwise performed.

A format selection request is received at block 902. At block 904, the additional format of the syndicated content is generated in accordance with the format selection request.

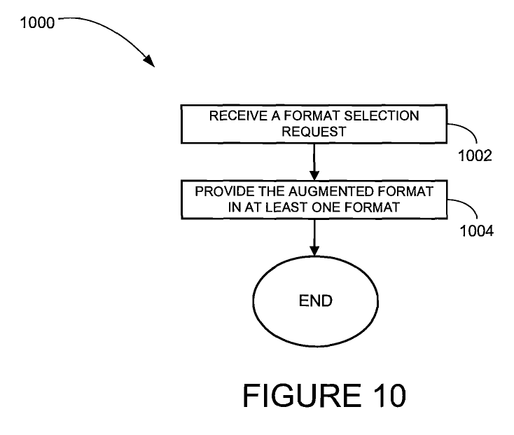

FIG. 10 illustrates a method 1000 for providing augmented content according to an example embodiment. The method 1000 may be performed at block 312 (see FIG. 3) otherwise performed.

A format selection request is received at block 1002. At block 1004, the augmented content is provided in at least one format through a target syndication feed in accordance with the format selection request.

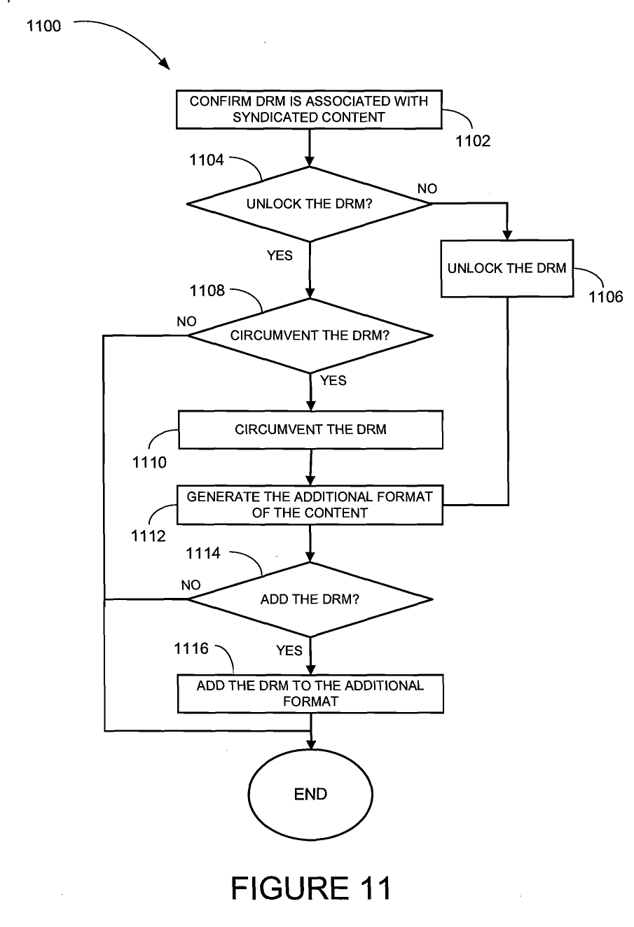

FIG. 11 illustrates a method 1100 for generating an additional format according to an example embodiment. The method 1100 may be performed at block 310 (see FIG. 3) or otherwise performed.

A confirmation that digital rights management (DRM) is associated with the syndicated content in an original format is made at block 1102.

At decision block 1104, a determination may be made whether to unlock the DRM associated with the original format. If a determination is made to unlock the DRM, the DRM associated with the original format may be unlocked at block 1106 and the method 1100 may proceed to block 1112. If a determination is made at decision block 1104 not to unlock the DRM, the method 1100 may proceed to decision block 1108.

A determination may be made at decision block 1108 whether to circumvent the DRM. If a determination is made to circumvent the DRM, the DRM associated with the original format may be circumvented at block 1110.

The additional format of the syndicated content is generated from the original format at block 1112.

At decision block 1114, a determination may be made whether to add the DRM to the additional format. If a determination is made to add the DRM, the DRM may be added to the additional format at block 1116. If a determination is made at decision block 1114 not to add the DRM, if a determination is made not to circumvent the DRM at decision block 1108, or upon the completion of the operations at block 1116, the method 1100 may terminate.

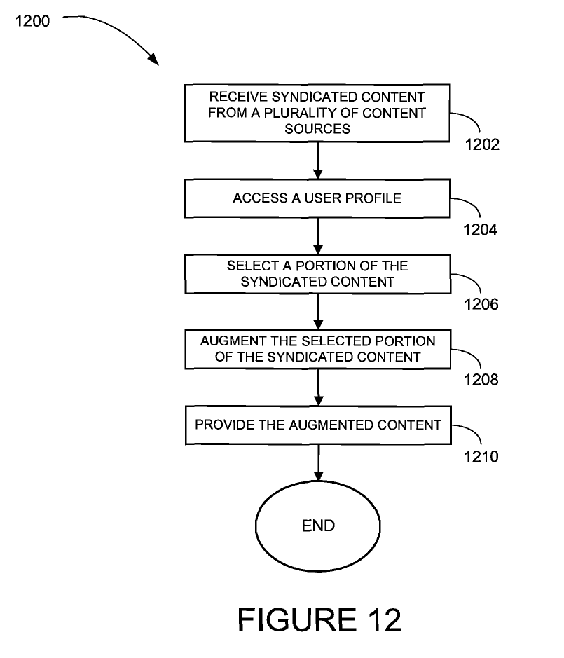

FIG. 12 illustrates a method 1200 for providing content according to an example embodiment. The method 1200 may be performed by the resyndicator 102 of the content system 100 or otherwise performed.

Syndicated content is received from a number of content syndication sources 106 at block 1202. A user profile may be accessed at block 1204.

At block 1206, a portion of the syndicated content is selected from a number of content syndication sources 106. The portion of the syndicated content may be selected in accordance with the user profile. In an example embodiment, selecting portions from different content syndication sources 106 may enable a user to watch a variety of difference scenes from multiple content syndication sources 106 in a single content syndication feed.

The selected portion of syndicated content from the plurality of content syndication sources is augmented with metadata at block 1208.

The augmented content is provided through a target syndication feed at block 1210.

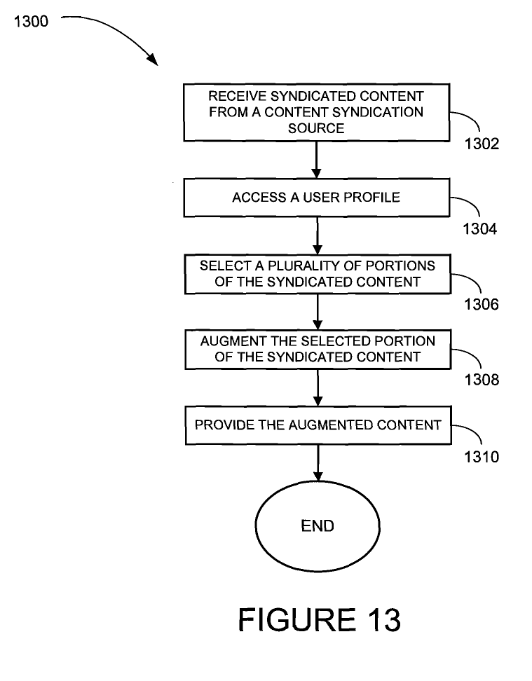

FIG. 13 illustrates a method 1300 for providing content according to an example embodiment. The method 1300 may be performed by the resyndicator 102 of the content system 100 or otherwise performed.

Syndicated content is received from the content syndication sources 106 at block 1302. A user profile may be accessed at block 1304.

At block 1306, a number of portions of the syndicated content are selected from the content syndication source 106. The selection of the portions may be in accordance with the user profile. In an example embodiment, selecting different portions from the content syndication source 106 may enable a user to watch a variety of difference scenes from a single content syndication source. For example, the difference scenes may include most watched scenes, most relevant scenes, scene highlights, and the like.

The selected portions of the syndicated content are augmented with metadata at block 1308. The augmented content is provided through a target syndication feed at block 1310.

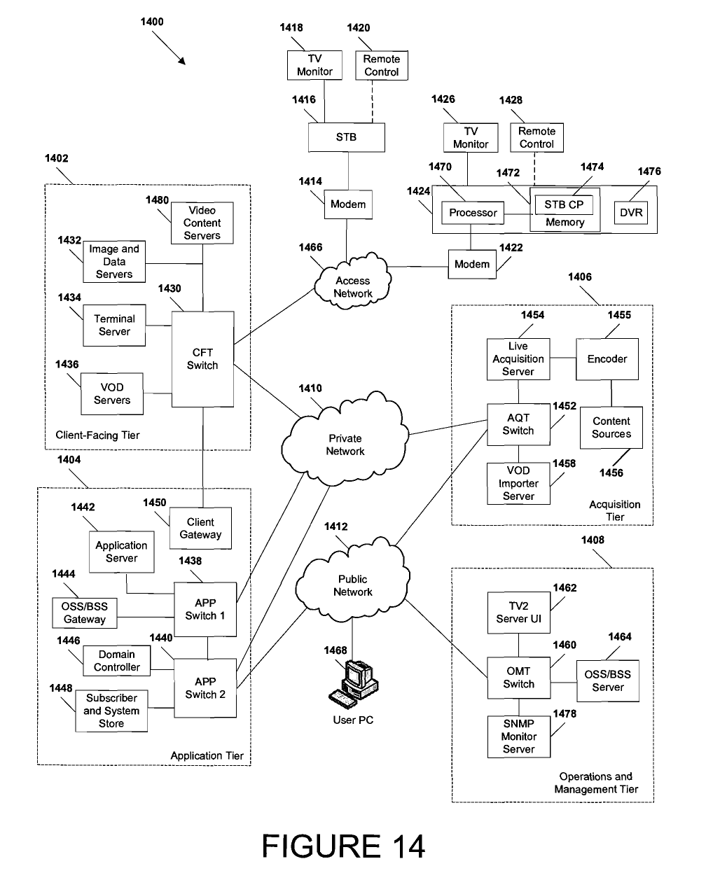

FIG. 14 illustrates an example embodiment of an Internet Protocol Television (IPTV) system 1400 in which the content system 100 may be deployed. However, the content systems 100 may be deployed in other types of IPTV and non-IPTV video systems.

The system 1400 as illustrated may include a client facing tier 1402, an application tier 1404, an acquisition tier 1406, and an operations and management tier 1408. Some tiers 1402, 1404, 1406, 1408 may be coupled to a private network 1410; to a public network 1412, such as the Internet; or to both the private network 1410 and the public network 1412. For example, the client-facing tier 1402 may be coupled to the private network 1410. Further, the application tier 1404 may be coupled to the private network 1410 and to the public network 1412. The acquisition tier 1406 may also be coupled to the private network 1410 and to the public network 1412. Additionally, the operations and management tier 1408 may be coupled to the public network 1412.

As illustrated in FIG. 14, some of the various tiers 1402, 1404, 1406, 1408 may communicate with each other via the private network 1410 and the public network 1412. For instance, the client-facing tier 1402 may communicate with the application tier 1404 and the acquisition tier 1406 via the private network 1410. The application tier 1404 may also communicate with the acquisition tier 1406 via the private network 1410. Further, the application tier 1404 may communicate with the acquisition tier 1406 and the operations and management tier 1408 via the public network 1412. Moreover, the acquisition tier 1406 may communicate with the operations and management tier 1408 via the public network 1412. In a particular As illustrated in FIG. 14, the client-facing tier 1402 may communicate with user equipment via a private access network 1466 (e.g., the provider network 104 of FIG. 1), such as an Internet Protocol Television (IPTV) access network. In an illustrative embodiment, modems, such as a first modem 1414 and a second modem 1422 may be coupled to the private access network 1466. The client-facing tier 1402 may communicate with a first representative set-top box device 1416 via the first modem 1414 and with a second representative set-top box device 1424 via the second modem 1422. The client-facing tier 1402 may communicate with a large number of set-top boxes, such as the representative set-top boxes 1416, 1424, (e.g., the target device 108 of FIG. 1) over a wide geographic area, such as a regional area, a metropolitan area, a viewing area, a designated market area or any other suitable geographic area, market area, or subscriber or customer group that may be supported by networking the client-facing tier 1402 to numerous set-top box devices. In an illustrative embodiment, the client-facing tier, or any portion thereof, may be included at a video head-end office.

In a particular embodiment, the client-facing tier 1402 may be coupled to the modems 1414, 1422 via fiber optic cables. Alternatively, the modems 1414 and 1422 may be digital subscriber line (DSL) modems that are coupled to one or more network nodes via twisted pairs, and the client-facing tier 1402 may be coupled to the network nodes via fiber-optic cables. Each set-top box device 1416, 1424 may process data received via the private access network 1466, via an IPTV software platform, such as Microsoft® TV IPTV Edition. In another embodiment, representative set-top boxes 1416, 1424 may receive data from private access network 1466 through RF and other cable and/or satellite based networks.

Additionally, the first set-top box device 1416 may be coupled to a first external display device, such as a first television monitor 1418, and the second set-top box device 1424 may be coupled to a second external display device, such as a second television monitor 1426. Moreover, the first set-top box device 1416 may communicate with a first remote control 1420, and the second set-top box device may communicate with a second remote control 1428.

In an example, non-limiting embodiment, one or more of set-top box devices 1416, 1424 may receive video content, which may include video and audio portions, from the client-facing tier 1402 via the private access network 1466. The set-top boxes 1416, 1424 may transmit the video content to an external display device, such as the television monitors 1418, 1426. Further, some of the set-top box devices 1416, 1424 may include a STB processor, such as STB processor 1470, and a STB memory device, such as STB memory 1472, which is accessible to the STB processor 1470. In one embodiment, a computer program, such as the STB computer program 1474, may be embedded within the STB memory device 1472. Some set-top box devices 1416, 1424 may also include a video content storage module, such as a digital video recorder (DVR) 1476. In a particular embodiment, the set-top box devices 1416, 1424 may communicate commands received from the remote control devices 1420, 1428 to the client-facing tier 1402 via the private access network 1466.

In an illustrative embodiment, the client-facing tier 1402 may include a client-facing tier (CFT) switch 1430 that manages communication between the client-facing tier 1402 and the private access network 1466 and between the client-facing tier 1402 and the private network 1410. As shown, the CFT switch 1430 is coupled to one or more image and data servers 1432 that store still images associated with programs of various IPTV channels. The image and data servers 1432 may also store data related to various channels, e.g., types of data related to the channels and to programs or video content displayed via the channels. In an illustrative embodiment, the image and data servers 1432 may be a cluster of servers, some of which may store still images, channel and program-related data, or any combination thereof. The CFT switch 1430 may also be coupled to a terminal server 1434 that provides terminal devices with a connection point to the private network 1410. In a particular embodiment, the CFT switch 1430 may also be coupled to one or more video-on-demand (VOD) servers 1436 that store or provide VOD content imported by the IPTV system 1400. In an illustrative, non-limiting embodiment, the VOD content servers 1480 may include one or more unicast servers.

The client-facing tier 1402 may also include one or more video content servers 1480 that transmit video content requested by viewers via their set-top boxes 1416, 1424. In an illustrative, non-limiting embodiment, the video content servers 1480 may include one or more multicast servers.

As illustrated in FIG. 14, the application tier 1404 may communicate with both the private network 1410 and the public network 1412. The application tier 1404 may include a first application tier (APP) switch 1438 and a second APP switch 1440. In a particular embodiment, the first APP switch 1438 may be coupled to the second APP switch 1440. The first APP switch 1438 may be coupled to an application server 1442 and to an OSS/BSS gateway 1444. In a particular embodiment, the application server 1442 may provide applications to the set-top box devices 1416, 1424 via the private access network 1466, which enable the set-top box devices 1416, 1424 to provide functions, such as display, messaging, processing of IPTV data and VOD material, etc. In a particular embodiment, the OSS/BSS gateway 1444 includes operation systems and support (OSS) data, as well as billing systems and support (BSS) data. In one embodiment, the OSS/BSS gateway may provide or restrict access to an OSS/BSS server 1464 that stores operations and billing systems data.

Further, the second APP switch 1440 may be coupled to a domain controller 1446 that provides web access, for example, to users via the public network 1412. For example, the domain controller 1446 may provide remote web access to IPTV account information via the public network 1412, which users may access using their personal computers 1468. The second APP switch 1440 may be coupled to a subscriber and system store 1448 that includes account information, such as account information that is associated with users who access the system 1400 via the private network 1410 or the public network 1412. In a particular embodiment, the application tier 1404 may also include a client gateway 1450 that communicates data directly with the client-facing tier 1402. In this embodiment, the client gateway 1450 may be coupled directly to the CFT switch 1430. The client gateway 1450 may provide user access to the private network 1410 and the tiers coupled thereto.

In a particular embodiment, the set-top box devices 1416, 1424 may access the IPTV system 1400 via the private access network 1466, using information received from the client gateway 1450. In this embodiment, the private access network 1466 may provide security for the private network 1410. User devices may access the client gateway 1450 via the private access network 1466, and the client gateway 1450 may allow such devices to access the private network 1410 once the devices are authenticated or verified. Similarly, the client gateway 1450 may prevent unauthorized devices, such as hacker computers or stolen set-top box devices from accessing the private network 1410, by denying access to these devices beyond the private access network 1466.

For example, when the first representative set-top box device 1416 accesses the system 1400 via the private access network 1466, the client gateway 1450 may verify subscriber information by communicating with the subscriber and system store 1448 via the private network 1410, the first APP switch 1438, and the second APP switch 1440. Further, the client gateway 1450 may verify billing information and status by communicating with the OSS/BSS gateway 1444 via the private network 1410 and the first APP switch 1438. In one embodiment, the OSS/BSS gateway 1444 may transmit a query across the first APP switch 1438, to the second APP switch 1440, and the second APP switch 1440 may communicate the query across the public network 1412 to the OSS/BSS server 1464. After the client gateway 1450 confirms subscriber and/or billing information, the client gateway 1450 may allow the set-top box device 1416 access to IPTV content and VOD content. If the client gateway 1450 is unable to verify subscriber information for the set-top box device 1416, e.g., because it is connected to an unauthorized twisted pair, the client gateway 1450 may block transmissions to and from the set-top box device 1416 beyond the private access network 1466.

As indicated in FIG. 14, the acquisition tier 1406 includes an acquisition tier (AQT) switch 1452 that communicates with the private network 1410. The AQT switch 1452 may also communicate with the operations and management tier 1408 via the public network 1412. In a particular embodiment, the AQT switch 1452 may be coupled to a live acquisition server 1454 that receives television or movie content, for example, from content sources 1456 through an encoder 1455. In a particular embodiment during operation of the IPTV system, the live acquisition server 1454 may acquire television or movie content. The live acquisition server 1454 may transmit the television or movie content to the AQT switch 1452 and the AQT switch 1452 may transmit the television or movie content to the CFT switch 1430 via the private network 1410.

Further, the television or movie content may be transmitted to the video content servers 1480, where it may be encoded, formatted, stored, or otherwise manipulated and prepared for communication to the set-top box devices 1416, 1424. The CFT switch 1430 may communicate the television or movie content to the modems 1414, 1422 via the private access network 1466. The set-top box devices 1416, 1424 may receive the television or movie content via the modems 1414, 1422, and may transmit the television or movie content to the television monitors 1418, 1426. In an illustrative embodiment, video or audio portions of the television or movie content may be streamed to the set-top box devices 1416, 1424.

Further, the AQT switch may be coupled to a video-on-demand importer server 1458 that stores television or movie content received at the acquisition tier 1406 and communicates the stored content to the VOD server 1436 at the client-facing tier 1402 via the private network 1410. Additionally, at the acquisition tier 1406, the video-on-demand (VOD) importer server 1458 may receive content from one or more VOD sources outside the IPTV system 1400, such as movie studios and programmers of non-live content. The VOD importer server 1458 may transmit the VOD content to the AQT switch 1452, and the AQT switch 1452, in turn, may communicate the material to the CFT switch 1430 via the private network 1410. The VOD content may be stored at one or more servers, such as the VOD server 1436.

When user issue requests for VOD content via the set-top box devices 1416, 1424, the requests maybe transmitted over the private access network 1466 to the VOD server 1436, via the CFT switch 1430. Upon receiving such requests, the VOD server 1436 may retrieve the requested VOD content and transmit the content to the set-top box devices 1416, 1424 across the private access network 1466, via the CFT switch 1430. The set-top box devices 1416, 1424 may transmit the VOD content to the television monitors 1418, 1426. In an illustrative embodiment, video or audio portions of VOD content may be streamed to the set-top box devices 1416, 1424.

FIG. 14 further illustrates that the operations and management tier 1408 may include an operations and management tier (OMT) switch 1460 that conducts communication between the operations and management tier 1408 and the public network 1412. In the embodiment illustrated by FIG. 14, the OMT switch 1460 is coupled to a TV2 server 1462. Additionally, the OMT switch 1460 may be coupled to an OSS/BSS server 1464 and to a simple network management protocol (SNMP) monitor 1478 that monitors network devices within or coupled to the IPTV system 1400. In a particular embodiment, the OMT switch 1460 may communicate with the AQT switch 1452 via the public network 1412.

In an illustrative embodiment, the live acquisition server 1454 may transmit the television or movie content to the AQT switch 1452, and the AQT switch 1452, in turn, may transmit the television or movie content to the OMT switch 1460 via the public network 1412. In this embodiment, the OMT switch 1460 may transmit the television or movie content to the TV2 server 1462 for display to users accessing the user interface at the TV2 server 1462. For example, a user may access the TV2 server 1462 using a personal computer (PC) 1468 coupled to the public network 1412.

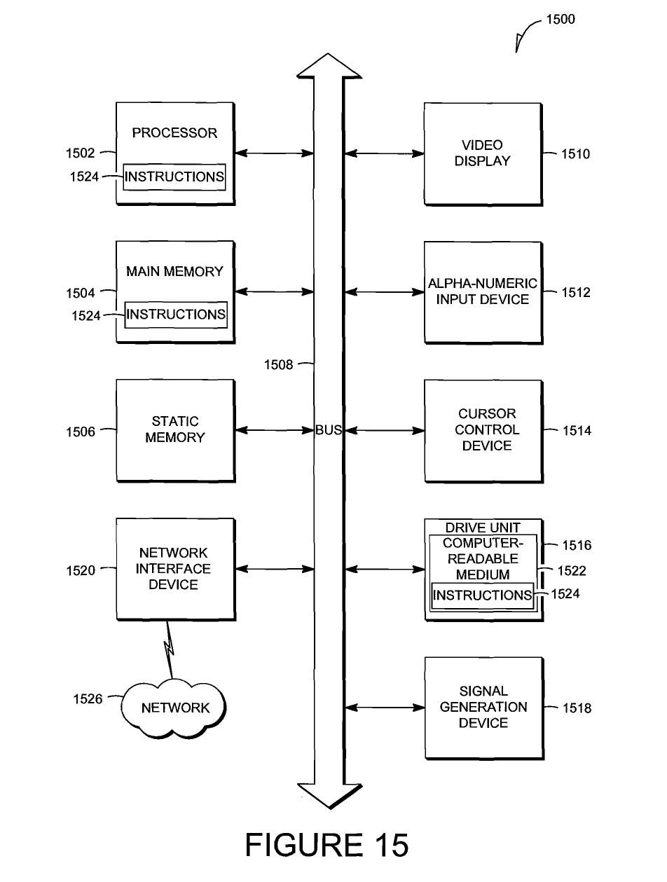

FIG. 15 shows a diagrammatic representation of machine in the example form of a computer system 1500 within which a set of instructions may be executed causing the machine to perform any one or more of the methods, processes, operations, or methodologies discussed herein. The resyndicator 102, the content syndication source 106, and/or the metadata source 112 may be deployed on the computer system 1500. The target device 108 may include the functionality of the computer system 1500.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU) a graphics processing unit (GPU) or both), a main memory 1504 and a static memory 1506, which communicate with each other via a bus 1508. The computer system 1500 may further include a video display unit 1510 (e.g., a liquid crystal display (LCD) or a cathode ray tube (CRT)). The computer system 1500 also includes an alphanumeric input device 1512 (e.g., a keyboard), a cursor control device 1514 (e.g., a mouse), a drive unit 1516, a signal generation device 1518 (e.g., a speaker) and a network interface device 1520.

The drive unit 1516 includes a machine-readable medium 1522 on which is stored one or more sets of instructions (e.g., software 1524) embodying any one or more of the methodologies or functions described herein. The software 1524 may also reside, completely or at least partially, within the main memory 1504 and/or within the processor 1502 during execution thereof by the computer system 1500, the main memory 1504 and the processor 1502 also constituting machine-readable media.

The software 1524 may further be transmitted or received over a network 1526 via the network interface device 1520.

While the machine-readable medium 1522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies shown in the various embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for providing content have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving syndicated content through a source syndication feed from a content syndication source;
augmenting the syndicated content with metadata; and
providing the augmented content through a target syndication feed.

2. The method of claim 1, wherein the augmenting of the syndicated content comprises:
augmenting existing metadata of the syndicated content with additional metadata.

3. The method of claim 1, wherein the augmenting of the syndicated content comprises:
extracting existing metadata from an original format of the syndicated content;
generating an additional format of the syndicated content; and
augmenting the additional format of the syndicated content with the existing metadata.

4. The method of claim 1, wherein the augmenting of the syndicated content comprises:
analyzing the syndicated content;
generating the metadata from the analysis; and
augmenting the syndicated content with the metadata.

5. The method of claim 1, wherein the augmenting of the syndicated content comprises:
analyzing the syndicated content and existing metadata, the existing metadata associated with the syndicated content;
generating additional metadata from the analysis; and
augmenting the syndicated content with the additional metadata.

6. The method of claim 5, wherein the analyzing of the syndicated content comprises:
accessing the existing metadata for the syndicated content from a metadata source; and
analyzing the syndicated content and the existing metadata.

7. The method of claim 5, wherein the analyzing of the syndicated content comprises:
accessing the existing metadata of the syndicated content; and
analyzing the syndicated content and the existing metadata of the syndicated content.

8. The method of claim 5, wherein the existing metadata is general metadata and the additional metadata is content specific metadata.

9. The method of claim 5, wherein the additional metadata includes at least one of a thumbnail image or speech recognized text.

10. The method of claim 1, wherein the providing of the augmented content comprises:
generating an additional format of the syndicated content; and
providing the augmented content in at least one format through the target syndication feed.

11. The method of claim 10, wherein the generating of the additional format comprises:
transcoding the syndicated content to generate the additional format.

12. The method of claim 10, wherein the generating of the additional format comprises:
utilizing a format criterion to determine a format type of the syndicated content; and
based on the determination, generating the additional format of the syndicated content.

13. The method of claim 12, wherein the format criterion is selected from a group of format criteria consisting of:
a display size of the target device,
a capability of the network
a coverage area of the network, or
combinations thereof.

14. The method of claim 10, wherein the generating of the additional format comprises:
accessing a user profile; and
generating the additional format of the syndicated content in accordance with the user profile.

15. The method of claim 10, wherein the generating of the additional format comprises:
receiving a format selection request; and
generating the additional format of the syndicated content in accordance with the format selection request.

16. The method of claim 10, wherein the providing of the augmented content comprises:
receiving a format selection request; and
providing the augmented content in at least one format through the target syndication feed in accordance with the format selection request.

17. The method of claim 10, wherein the providing of the augmented content comprises:
providing the augmented content in the additional format through the target syndication feed.

18. The method of claim 10, wherein providing of the augmented content comprises:
providing the augmented content in an original format and the additional format through the target syndication feed.

19. The method of claim 10, wherein the additional format includes at least one of a different display resolution than the original format, a different encoding format than the original format, or combinations thereof.

20. The method of claim 1, wherein the augmenting of the syndicated content comprises:
aligning the metadata with the syndicated content.

21. The method of claim 1, wherein the providing of the content comprises:
providing the augmented content through the target syndication feed to a target device.

22. The method of claim 1, wherein the providing of the content comprises:
providing the augmented content through the target syndication feed to the content syndication source.

23. A method comprising:
receiving syndicated content from a plurality of content syndication sources;
selecting a portion of the syndicated content from the plurality of content syndication sources;
augmenting the selected portion of syndicated content from the plurality of content syndication sources with metadata; and
providing the augmented content through a target syndication feed.

24. The method of claim 23, wherein the selecting of the portion comprises:
accessing a user profile; and
selecting the portion of the syndicated content from the plurality of content syndication sources in accordance with the user profile.

25. A machine-readable medium comprising instructions, which when implemented by one or more processors perform the following operations:
receive syndicated content from a content syndication source;
select a plurality of portions of the syndicated content from a content syndication source;
augment the selected plurality of portions of the syndicated content with metadata; and
provide the augmented content through a target syndication feed.

26. The machine-readable medium of claim 25, wherein the one or more instructions to select the portion include:
access a user profile; and
select the plurality of portions of the syndicated content from the content syndication source in accordance with the user profile.

27. A system comprising:
a content receiver module to receive syndicated content from a content syndication source;
an augmentation module to augment the syndicated content with metadata; and
a content provider module to provide the augmented content through a target syndication feed.

28. The system of claim 27, further comprising:
a digital rights management (DRM) module to determine digital rights management (DRM) associated with the syndicated content in an original format.

29. The system of claim 27, wherein the metadata includes at least one of a rendering instruction, a publication instruction, or combinations thereof.
